(19) United States
(12) Patent Application Publication
(10) Pub. No.: US 2003/0202269 A1
(43) Pub. Date: Oct. 30, 2003

(54) Method for storing or rescuing data or information

(76) Inventor: Jack Chen, Taichung (TW)

Correspondence Address: CHARLES E. BAXLEY, 5th Floor, 59 John Street, New York, NY, 10038, US

(21) Appl. No.: 10/134,074

(22) Filed: Apr. 29, 2002

(51) Int. Cl. G11B 5/09; G11B 5/02; G11B 27/36

(52) U.S. Cl. 360/48; 360/25; 360/53; 360/31

(57) ABSTRACT

A method includes tabling the information in a disc into ASCII codes, curving the codes into a curve or coordinates, and equating the curve to an equation, which may then be stored or transmitted to the other computer facilities. A series of representatives may be obtained with the equation and the coordinates, and may then be converted back to the coordinates, and back to the codes, and then back to an information for covering over the original information that may have been attacked and damaged by various kinds of computer viruses.

### BACKGROUND OF THE INVENTION

1. Field of the Invention

The present invention relates to a method for processing discs or files, and more particularly to a method for processing and/or storing and/or rescuing the data or the information or the files in the disks or the like.

2. Description of the Prior Art

Various kinds of computer viruses have been developed for attacking or damaging the computer facilities today, and many more computer viruses have been further developed everyday. Not only the personal computers may be damaged by the computer viruses, but also many large computer facilities or systems may be damaged or become fail by the computer viruses. For example, the computer systems of the whole company, or of the airplanes, or of the defensive systems of the countries, etc., may all be damaged by computer viruses easily and quickly.

The files or the data or the information in the hard discs or the floppy discs or the like may include a large volume that may not be easily stored or copied or saved in the discs as the spare data or information or files. For example, if one half of the hard disc is divided for storing the spare files, the hard disc will have only one half thereof for operating purposes. At present, the files or the data or the information in the hard discs or the floppy discs or the like may not be suitably processed and stored as the spare data or information or files.

In addition, at present, almost all of the rescuing files or programs are each developed for attacking or killing a particular computer virus only. The rescuing files or programs may not be used for rescuing all of the disks or files, such that the developing speed of the rescuing files or programs is always slower than the developing or growing speed of the computer viruses. The computer viruses have now caused great problems to the users, and have become the greatest headache problem to the computer users.

The present invention has arisen to mitigate and/or obviate the afore-described disadvantages of the conventional disc rescuing methods.

### SUMMARY OF THE INVENTION

The primary objective of the present invention is to provide a method for processing and/or storing the data or the information or the files in discs or the like, as the spare information, with equations.

The other objective of the present invention is to provide a method for reviving or rescuing the information of files or in discs or the like, particularly after the disks or files have been damaged by any kind of viruses.

The further objective of the present invention is to provide a method for transmitting the information of files or in discs or the like, with the processed data or files or information.

In accordance with one aspect of the invention, there is provided a method for processing information in a disc, the method comprising tabling the information into ASCII codes, curving the codes into a curve, and equating the curve into an equation, which may then be stored as a spare file, or may be transmitted to the other computer facilities for easily and quickly transmitting the information in the disc to the other places.

The ASCII codes may then be converted into coordinates for curving the codes into the curve. The coordinates may then be back to the codes, and the codes may then be converted back to a converted information, which may then be copied or covered over the original information that may have been attacked and damaged by various kinds of computer viruses.

A series of representatives may be obtained with the equation and the coordinates, and the equation and the representatives may then be converted back to the coordinates. The coordinates may then be back to the codes, and the codes may then be converted back to a converted information, which may then be copied or covered over the original information that may have been attacked and damaged by various kinds of computer viruses.

Further objectives and advantages of the present invention will become apparent from a careful reading of a detailed description provided hereinbelow, with appropriate reference to accompanying drawings.

### BRIEF DESCRIPTION OF THE DRAWINGS

FIGS. 1-1, and 1-2 illustrate a code translation table listing the relationship between the characters, the symbols, the marks, or the signs, and the decimal system, the hex system, and the binary system;

FIG. 2 is a diagram illustrating the locating or curving of the words, the files, or the information in the discs, with a method in accordance with the present invention;

FIG. 3 is a diagram similar to FIG. 2, illustrating the locating or curving or equating processes of the words, files, or discs;

FIG. 4 is a flow chart illustrating the processes for locating or curving or equating the files or the information or the like;

FIG. 5 is a flow chart illustrating the developing the data or the information or the files from the obtained equation; and

FIG. 6 is another flow chart illustrating the processes for further reviving or rescuing or protecting the data or the files or the information in the disks.

### DETAILED DESCRIPTION OF THE PREFERRED EMBODIMENT

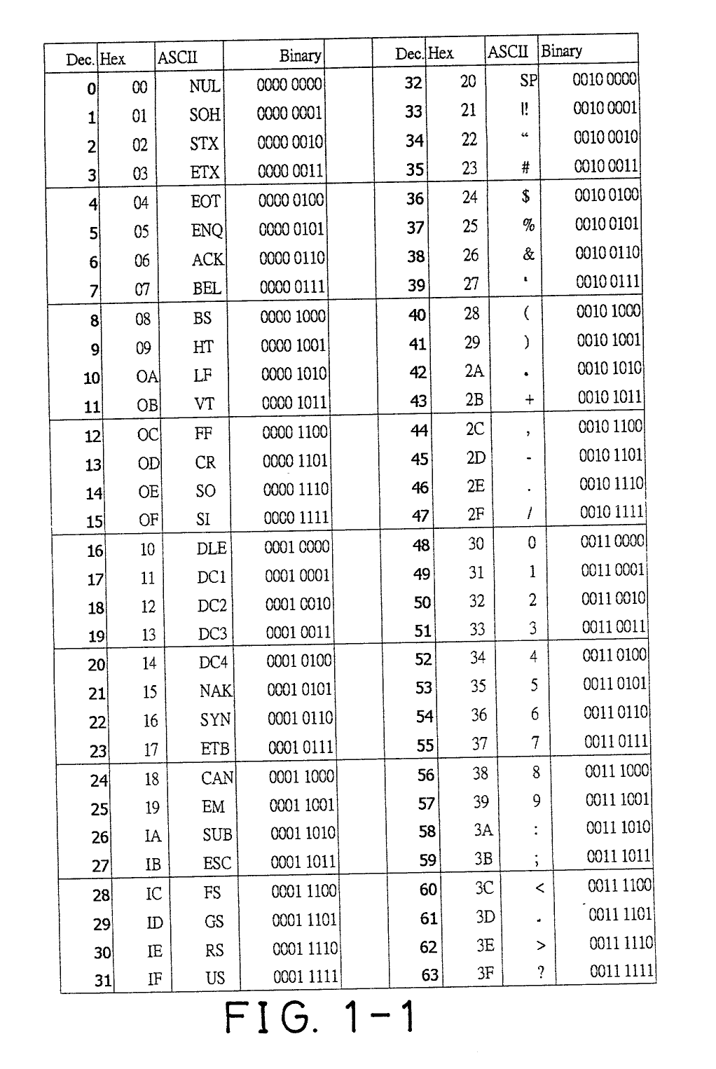

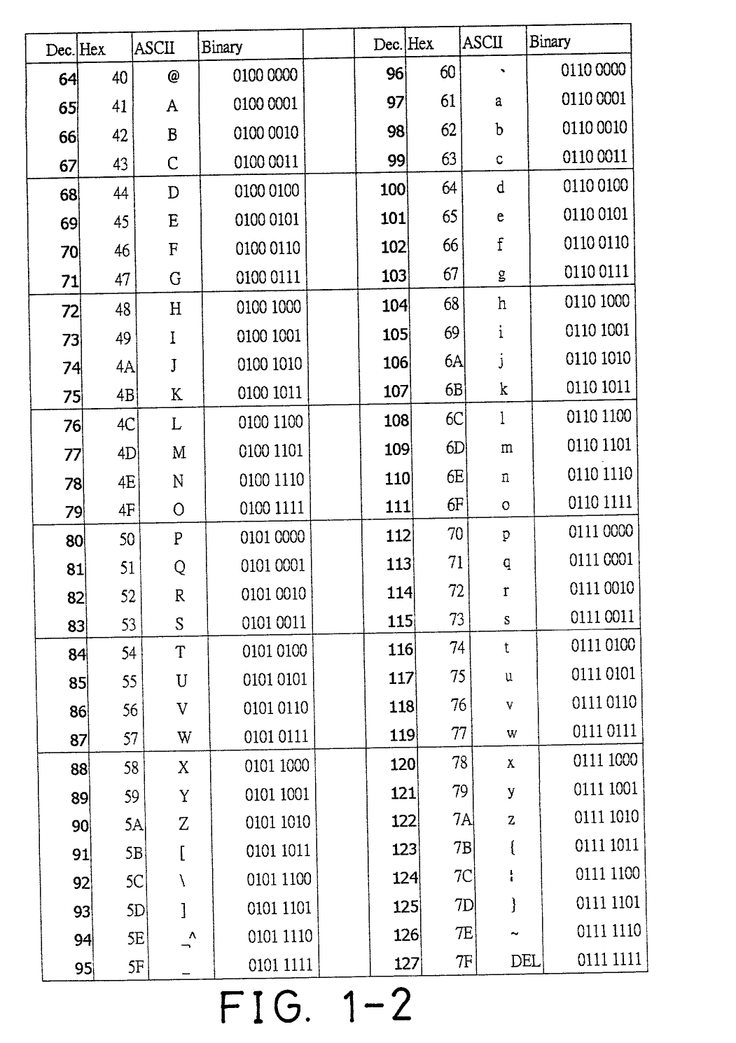

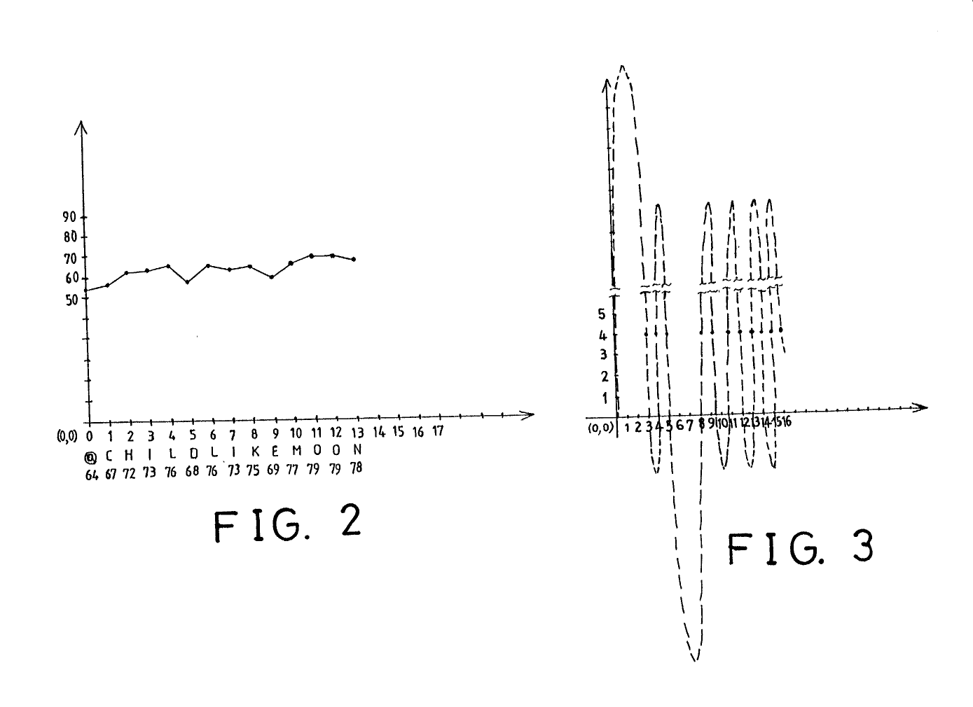

Referring to the drawings, and initially to FIGS. 1-1, and 1-2, illustrated is an ASCII code translation table listing the relationship between the characters, the symbols, the marks, or the signs, and the decimal system, the hex system, and the binary system. The characters, the symbols, the marks, or the signs, may each be represented by a decimal number, and a hex number, and a binary number. The ASCII code translation table include 256 characters (from 0 to 255), in which only one half of the characters have been shown in FIGS. 1-1 and 1-2.

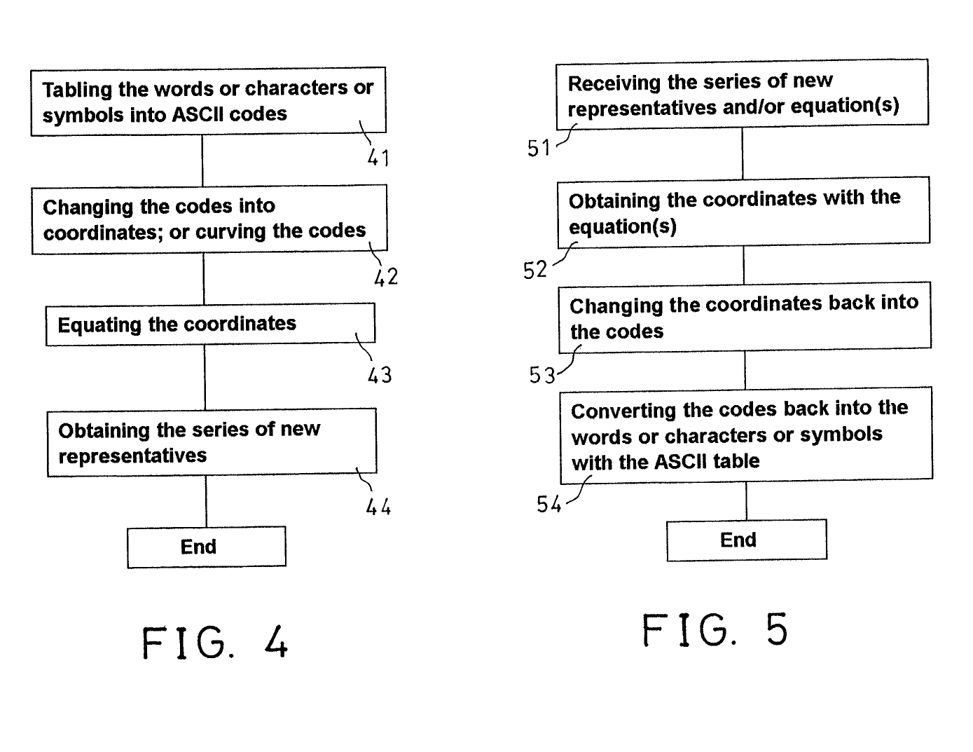

For example, the marks “;”, “.”, and “,” may each be represented by a decimal number “59, 46, 44”, and a hex number “3B, 2E, 2C”, and a binary number “0011 1011”, “0010 1110”, and “0010 1100” respectively. The character “@” may be represented by a decimal number “64”, and a hex number “40”, and a binary number “0100 0000”. The character “C” may be represented by a decimal number “67”, and a hex number “43”, and a binary number “0100 0011”. The characters “H, I, L, D, L, I, K, E, M, O, O, N” may each be represented by a decimal number “72, 73, 76, 68, 76, 73, 75, 69, 77, 79, 79, 78” respectively. The process 41 for obtaining the decimal numerals or the ASCII codes is illustrated in FIG. 4.

As shown in FIG. 2, the characters and/or symbols of the words “@CHILD LIKE MOON” thus may each be represented with a decimal number, and a hex number, and a binary number. For example, when using the decimal numbers, the words “@CHILD LIKE MOON” may be arranged in series, and the decimal numbers: 64, 67, 72, 73, 76, 68, 76, 73, 75, 69, 77, 79, 79, 78 of the words or characters or symbols may be drafted or located into a curve as shown in FIG. 2. The curve or the series of numerals may then be equated with any kind of equations. One example for equating the curve is described hereinafter.

For example, the decimal numbers: 64, 67, 72, 73, 76, 68, 76, 73, 75, 69, 77, 79, 79, 78 of the words or characters or symbols: “@CHILD LIKE MOON” may be located or rearranged into different coordinates, with such as the equation: y×16+x=N (the numerals). For example, when taken y as 4, 4×16+0=64 may be represented by the coordinate: (0,4); 4×16+3=67 may be represented by the coordinate: (3,4); 4×16+8=72 may be represented by the coordinate: (8,4); 4×16+9=73 may be represented by the coordinate: (9,4); 4×16+12=76 may be represented by the coordinate: (12,4); 4×16+4=68 may be represented by the coordinate: (4,4); 4×16+11=75 may be represented by the coordinate: (11,4); 4×16+5=69 may be represented by the coordinate: (5,4); 4×16+13=77 may be represented by the coordinate: (13,4); 4×16+15=79 may be represented by the coordinate: (15,4); 4×16+14=78 may be represented by the coordinate: (14,4).

Referring next to FIG. 3, the coordinates of the decimal numbers: 64, 67, 72, 73, 76, 68, 76, 73, 75, 69, 77, 79, 79, 78 of the words or characters or symbols: “@CHILD LIKE MOON” may thus be located or drafted or designated into the curve as shown in FIG. 3. The process 42 for changing the codes into the coordinates or for curving the codes is illustrated in FIG. 4.

An equation may then be obtained for representing these coordinates or points: y=4+x(x−3)(x−4)(x−5)(x−8) (x−9)(x−11)(x−12)(x−13)(x−14)(x−15). The process 43 for equating the coordinates is illustrated in FIG. 4. Accordingly, for y=4, the x code values of the decimal numbers: 64, 67, 72, 73, 76, 68, 76, 73, 75, 69, 77, 79, 79, 78 may thus be obtained, in series, as: 0, 3, 8, 9, 12, 4, 12, 9, 11, 5, 13, 15, 15, 14. The process 44 for obtaining the new series of representatives or numerals or symbols is illustrated in FIG. 4.

A two dimensional coordinate or equation may thus be obtained, as shown in FIG. 3. Similarly, various kinds of words or characters or symbols may be located or equated with various kinds equations, such as the sin, cos, tan, . . . etc. equations, or may even be equated with three (3) or more dimensional coordinates or equations, such as the integrated formulas or equations, the divergence equations, the Taylor series of equations, the generalized or complex Fourier series equations, etc.

Referring next to FIG. 5, illustrated is the processed for changing or converting the obtained equation(s) and/or the series of representatives or numerals or symbols back to the original characters, words, or symbols. For example, when receiving the obtained equation(s) and/or the series of representatives or numerals or symbols in the process 51, the coordinates may then be obtained with the obtained equation(s) and the series of representatives or numerals or symbols in the process 52. The coordinates may then be changed or converted back into the codes or the decimal numerals with the equation. N=y×16+x, in the process 53. The codes or the decimal numerals may then be converted back into the original characters, words, or symbols with the ASCII table, in the process 54.

It is to be noted that the obtained equation(s) and/or the series of representatives or numerals or symbols may thus be stored as a spare file, for further use. For example, the obtained equation(s) and/or the series of representatives or numerals or symbols may be copied or stored or memorized in the floppy discs, or in the other areas that the other person may not be entered. For example, the hard discs may be divided into several areas, and may have one or more of the divided areas kept out from being reached by the other unauthorized persons, or from being attacked or damaged by the computer viruses.

Particularly, when the original files or data or information has been attacked or damaged by various kinds of computer viruses, the spare file may then be used or copied over the damaged files or information, in order to revive or to rescue the information or files right away, no matter what kind of computer viruses have attack and damage the original information or files or data.

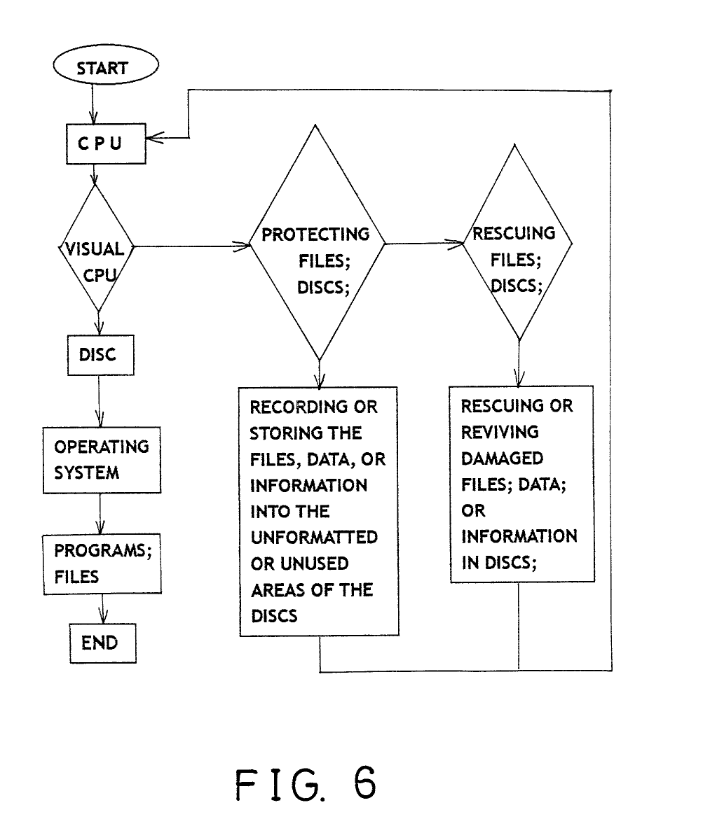

Referring next to FIG. 6, illustrated is the other example for protecting or rescuing the damaged files or data or information that have been attacked by the computer viruses. For example, a visual central processing unit (visual CPU) 60 is provided and arranged between the CPU 61 and the discs 62 of the computer facilities, for allowing the files and/or the information in the discs 62 of the computer facilities to be entered and operated only after entering through the visual CPU 60, and for allowing the operating systems 63 and/or the files and/or the information 64 in the discs 62 to be entered and operated only after the users have entered into the discs 62.

For example, before or after entering into the discs 62 of the computer facilities, the users may enter into a discs-and/or-files protecting mode 65 via the visual CPU 60, in order to record or to copy or to store the files, the data, or the information in the discs into the unformatted or unused areas of the discs, or into the other hard discs and/or floppy discs, or into the other spare areas, as the spare information, in the process 66.

Before entering into the discs 62 of the computer facilities, the users may also enter into a discs-and/or-files rescuing mode 67 via the visual CPU 60, before or after the protecting mode 65. For example, the files, the data, or the information in the discs may have been damaged by the computer viruses. However, the files, the data or the information may have previously been stored in the unformatted or unused areas of the discs or in the other hard discs and/or floppy discs in the protecting mode 65, before the discs have been damaged. The files, the data or the information that have been previously stored and/or protected in the unformatted or unused areas of the discs or in the other hard discs and/or floppy discs may then be copied and/or formatted and/or covered over the damaged files and/or discs, in order to rescue or to revive the damaged files and/or data, and/or information in the discs in the process 68.

Accordingly, the damaged files or information or discs may be covered by the newly copied files or information, for preventing the users from entering into the damaged files or discs. Or, when the users knew that the files and/or the discs have been attacked or damaged by the computer viruses, the users may turn off the computer facility right away, and may re-energize or re-open the computer facility again, in order to enter into the visual CPU 60 without entering into the damaged discs, and in order to copy the stored files and/or data and/or information onto the damaged files and/or data and/or information of the discs, and so as to rescue or to revive the damaged discs. The protecting and/or rescuing processes as shown in FIG. 6 will be filed in a co-pending U.S. Patent Application separately, which may then be taken as a reference for the present invention.

It is further to be noted that the words, the files, or the information in the discs may be converted into the ASCII codes, and may then be located into various kinds of curves, and may then be equated into various kinds of equations and/or representatives. The equations may then be stored as the spare files for further use, such as for reviving or for rescuing the damaged files or information. The equations, before or after storing, may also be transmitted to the other places or to the other computers, and may then be converted back into the words, the files, or the information, such that the transmitting speed of the words, the files, or the information may be greatly increased.

Accordingly, the method in accordance with the present invention may be used for processing and/or storing the data or the information or the files in discs or the like, as the spare information; and/or for reviving or rescuing the information of files or in discs or the like, particularly after the disks or files have been damaged by any kind of viruses; and/or for transmitting the information of files or in discs or the like, with the processed data or files or information.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for processing information in a disc, said method comprising:
tabling the information into ASCII codes,
curving said codes into a curve, and
equating said curve into an equation.

2. The method according to claim 1 further comprising converting said ASCII codes into coordinates for curving said codes into said curve.

3. The method according to claim 2 further comprising converting said coordinates back to said codes.

4. The method according to claim 3 further comprising converting said codes back to a converted information.

5. The method according to claim 4 further comprising covering said converted information over the original information.

6. The method according to claim 2 further comprising obtaining a series of representatives with said equation and said coordinates.

7. The method according to claim 6 further comprising converting said equation and said representatives back to said coordinates.

8. The method according to claim 7 further comprising converting said coordinates back to said codes.

9. The method according to claim 8 further comprising converting said codes back to a converted information.

10. The method according to claim 9 further comprising covering said converted information over the original information.

11. The method according to claim 1 further comprising converting said equation back to said curve.

12. The method according to claim 11 further comprising converting said curve back to said codes.

13. The method according to claim 12 further comprising converting said codes to a converted information.

14. The method according to claim 13 further comprising covering said converted information over the original information.

15. The method according to claim 1 further comprising storing said equation.

16. The method according to claim 1 further comprising transmitting said equation out of said disc.
